(19) United States
(12) Patent Application Publication
(10) Pub. No.: US 2024/0321127 A1
(43) Pub. Date: Sep. 26, 2024

(54) METHOD AND SYSTEM FOR GROUND TRAVEL COLLISION AVOIDANCE OF AIRCRAFT

(71) Applicants: CHINA EASTERN AIRLINES CO., LTD., Shanghai (CN); EASTERN AIRLINES TECHNIC CO., LTD., Shanghai (CN); CHINA EASTERN TECHNOLOGY APPLICATION RESEARCH AND DEVELOPMENT CENTER CO., LTD., Shanghai (CN)

(72) Inventors: Weijie CHENG, Shanghai (CN); Zhidong GAO, Shanghai (CN); Shaokun SONG, Shanghai (CN); Qian ZHANG, Shanghai (CN); Haoqing TANG, Shanghai (CN); Jie LIU, Shanghai (CN); Xiaocheng DING, Shanghai (CN); Yu LIU, Shanghai (CN)

(21) Appl. No.: 18/579,122

(22) PCT Filed: Jun. 10, 2022
(86) PCT No.: PCT/CN2022/098257

§ 371 Date: Jan. 12, 2024

(30) Foreign Application Priority Data
Jul. 14, 2021 (CN) 202110793966.5

(51) Int. Cl. G08G 5/04; G01S 17/89; G01S 17/933; G08G 5/00; G08G 5/06

(52) U.S. Cl. CPC G08G 5/045; G01S 17/89; G01S 17/933; G08G 5/0021; G08G 5/065

(57) ABSTRACT

The present disclosure relates to a method for ground travel collision avoidance of an aircraft, comprising: sensing, by a sensing module mounted on a towing vehicle for the aircraft, an object in a surrounding environment of the aircraft; determining whether the object is secure based on a contour feature of the aircraft and a relative position relation between the object and the aircraft; and implementing a collision avoidance measure in response to determining that the object is insecure. The present disclosure also relates to a system and a device for ground travel collision avoidance of an aircraft.

### TECHNICAL FIELD

The present disclosure relates to a method and system for ground travel collision avoidance of an aircraft.

### BACKGROUND

After landing and before takeoff of the aircraft, for example, in scenarios such as pushout from a stand, migration between stands, and warehousing for maintenance, the aircraft typically needs to travel on the ground, for example, it may travel by using thrust from an engine of the aircraft and/or traction from a towing vehicle. Due to limited sight of a driver in the aircraft or towing vehicle, together with a large volume of the aircraft itself, a specific position of each portion of the aircraft cannot be accurately known. Therefore, in the process that the aircraft travels on the ground, the driver can only estimate an external contour position of the aircraft through experience, which might cause scrapes and collisions with objects such as other aircrafts all around, and has great potential security hazards.

### SUMMARY

One of objectives of the present disclosure is to provide a method and system for ground travel collision avoidance of an aircraft.

According to a first aspect of the present disclosure, there is provided a method for ground travel collision avoidance of an aircraft, comprising: sensing, by a sensing module mounted on a towing vehicle for the aircraft, an object in a surrounding environment of the aircraft; determining whether the object is secure based on a contour feature and a travel feature of the aircraft; and implementing a collision avoidance measure in response to determining that the object is insecure.

According to a second aspect of the present disclosure, there is provided a system for ground travel collision avoidance of an aircraft, comprising: a sensing module mounted on a towing vehicle for the aircraft and configured to sense an object in a surrounding environment of the aircraft; a decision module configured to determine whether the object is secure based on a contour feature and a travel feature of the aircraft; and an execution module configured to implement a collision avoidance measure in response to determining that the object is insecure.

According to a third aspect of the present disclosure, there is provided a device for ground travel collision avoidance of an aircraft, comprising: one or more processors; and one or more memories configured to store a series of computer-executable instructions which, when executed by the one or more processors, cause the one or more processors to perform the method as described above.

According to a fourth aspect of the present disclosure, there is provided a non-transitory computer-readable storage medium characterized in that the non-transitory computer-readable storage medium has thereon stored a series of computer-executable instructions which, when executed by one or more computing apparatuses, cause the one or more computing apparatuses to perform the method as described above.

Other features and advantages thereof of the present disclosure will become apparent from the following detailed description of exemplary embodiments of the present disclosure with reference to the accompanying drawings.

### BRIEF DESCRIPTION OF THE DRAWINGS

The accompanying drawings, which constitute part of the specification, describe embodiments of the present disclosure and together with the description, serve to explain the principles of the present disclosure.

The present disclosure may be more clearly understood according to the following detailed description by referring to the accompanying drawings, in which:

FIG. 1 is an exemplary flow diagram of a method for ground travel collision avoidance of an aircraft according to an embodiment of the present disclosure.

FIG. 2 is an exemplary block diagram of a system for ground travel collision avoidance of an aircraft according to an embodiment of the present disclosure.

FIG. 3 is an exemplary flow diagram of a method for ground travel collision avoidance of an aircraft according to an embodiment of the present disclosure.

FIG. 4 is an exemplary block diagram of a system for ground travel collision avoidance of an aircraft according to an embodiment of the present disclosure.

FIG. 5 is an exemplary block diagram of a general hardware system applicable to various embodiments of the present disclosure.

Note that in the implementations illustrated below, sometimes same portions or portions having same functions are represented by jointly using same reference numerals between different drawings, and a repetitive description thereof will be omitted. In some cases, similar items are indicated using similar reference numbers and letters, and therefore, once an item is defined in a drawing, it need not be discussed further in subsequent drawings.

### DETAILED DESCRIPTION

The present disclosure will be described below with reference to the accompanying drawings, which illustrate several embodiments of the present disclosure. It should be understood, however, that the present disclosure may be presented in various different ways and is not limited to the embodiments described below; and in fact, the embodiments described below are intended to make the present disclosure more complete, and to fully convey the scope of protection of the present disclosure to those skilled in the art. It should be further understood that the embodiments disclosed herein can be combined in various ways to provide more additional embodiments.

It should be understood that the terms used herein are for the purpose of describing specific embodiments only, and are not intended to limit the present disclosure. All terms (including technical and scientific terms) used herein have meanings commonly understood by those skilled in the art, unless otherwise defined. Well-known functions or structures may not be described in detail for brevity and/or clarity.

The term “A or B”, herein, includes “A and B” and “A or B”, rather than exclusively including “A” or “B” only, unless specifically stated otherwise.

The term “exemplary”, herein, means “serving as an example, instance, or illustration”, rather than as a “model” that is to be reproduced exactly. Any implementation exemplarily described herein is not necessarily construed as preferred or advantageous over another implementation. Moreover, this disclosure is not limited by any expressed or implied theory presented in the preceding TECHNICAL FIELD, BACKGROUND, SUMMARY, OR DETAILED DESCRIPTION.

In addition, “first”, “second”, and similar terms may also be used herein for reference purposes only, and therefore, are not intended to be limiting. For example, the terms “first”, “second”, and other such numerical words related to structures or elements do not imply a sequence or order unless clearly indicated in the context.

It should be further understood that the term “comprise/include”, when used herein, indicates the presence of stated features, whole, steps, operations, units and/or components, but do not exclude the presence or addition of one or more other features, whole, steps, operations, units and/or components, and/or combinations thereof.

FIG. 1 is an exemplary flow diagram of the method 100 for ground travel collision avoidance of the aircraft according to an embodiment of the present disclosure. The method 100 includes: sensing, by the sensing module mounted on the towing vehicle for the aircraft, the object in the surrounding environment of the aircraft (step S110); determining whether the object is secure based on the contour feature of the aircraft and the relative position relation between the object and the aircraft (step S120); and implementing the collision avoidance measure in response to determining that the object is insecure (step S130). According to the method of the embodiment of the present disclosure, the surrounding environment of the aircraft is monitored by using the sensing module mounted on the towing vehicle of the aircraft, and the measure (for example, giving the alarm) can be taken in time to assist the driver in operating when the insecurity factor occurs, thereby avoiding collision in the process of the aircraft travelling on the ground, so as to improve security.

In some embodiments, the sensing module may include the laser radar. The laser radar may be used for sensing one or more objects in the surrounding environment of the aircraft. The object may include all human bodies or things that the sensing module may sense, including but not limited to an aircraft, a vehicle, a person, a building, a ground facility, an abnormal thing, and the like. In step S110, three-dimensional point cloud data of the surrounding environment of the aircraft that is sensed by the laser radar may be processed (for example, de-noised, clustered, etc.), thereby determining the object in the surrounding environment of the aircraft, for example, the contour feature of the object.

Furthermore, it is also necessary to determine the relative position relation between the object and the aircraft by the sensing module. The relative position relation between the object and the towing vehicle may be determined based on the data sensed by the sensing module, and the relative position relation between the object and the aircraft may be determined on basis of the known relative position relation between the towing vehicle and the aircraft. For example, coordinate values of data points sensed by the sensing module may be considered as coordinate values in the body coordinate system of the towing vehicle. According to the relative position relation between the towing vehicle and the aircraft (i.e. the relative position relation between the body coordinate system and the fuselage coordinate system), the coordinate values of these data points can be converted into the fuselage coordinate system of the aircraft to obtain point cloud data in the fuselage coordinate system, thereby determining the relative position relation between the object and the aircraft.

In some embodiments, the relative position relation between the aircraft and the towing vehicle may be sensed by using the sensing module. For example, by using point cloud data sensed by the laser radar mounted on the towing vehicle and oriented at least partially toward the aircraft (for example, at least a portion of the aircraft is included within the field angle of view of the laser radar), the relative position relation between the aircraft and the towing vehicle may be determined.

In some embodiments, the contour feature of the aircraft may include point cloud data of the contour of the aircraft. Contours of various models of aircrafts can be modeled in advance to establish the aircraft contour database in which point cloud data of the contours of the various models of aircrafts is stored. In step S120, the point cloud data of the contour of the aircraft may be extracted from the pre-established aircraft contour database according to the model of the aircraft. In some embodiments, the contour feature of the aircraft may include the dimension of the contour of the aircraft, for example, the length, width, height, wingspan, etc. of the fuselage of the aircraft. The aircraft contour database may be pre-established to store the dimensions of the contours of the various models of aircrafts. In step S120, the dimension of the contour of the aircraft may be extracted from the pre-established aircraft contour database according to the model of the aircraft.

The model of the aircraft may be determined in a number of ways. In some embodiments, the model of the aircraft may be determined according to the external feature of the aircraft that is sensed by the sensing module. Different models of aircrafts have different external features. The sensing module mounted on the towing vehicle may include the laser radar and/or the camera. Data sensed by the sensing module oriented at least partially toward the aircraft (for example, at least a portion of the aircraft is included within the field angle of view of the sensing module) may reflect the external feature of the aircraft. In one example, the point cloud data sensed by the laser radar may be subjected to pre-processing and then feature matching (for example, feature matching with the point cloud data of the contours of the various models of aircrafts) to automatically identify the model of the aircraft which the towing vehicle is currently operating. In one example, images (pictures or video) of the fuselage that are taken by the camera may be processed to identify the model of the aircraft. The model of the aircraft may be identified, for example, by graphical feature matching, or by identifying the registration number and/or model on the fuselage of the aircraft. In some embodiments, the model of the aircraft may be determined according to manual input. For example, there may be a human-machine interface (HMI) allowing manual input of the model of the aircraft on the towing vehicle, and the driver can input the model of the currently operated aircraft that may be learned, for example, from a command station by the HMI. In some embodiments, the model of the aircraft may be determined by using a combination of the two approaches described above. For example, the model of the aircraft is automatically identified through the data sensed by the sensing module, and assisted by the manual check, if an identification error is found, an updated model of the aircraft can be input through the HMI after rechecking.

In some embodiments, the travel feature of the aircraft may also be acquired by the sensing module. The travel feature may include the travel velocity and the travel acceleration of the aircraft. The sensing module mounted on the towing vehicle may further include the inertial navigation system for sensing the travel feature of the towing vehicle. In the process that the aircraft is towed by the towing vehicle for stable travel, the aircraft and the towing vehicle may be considered to be at relative rest. Therefore, the travel feature of the aircraft may be determined based on data sensed by the inertial navigation system.

In some embodiments, in step 120, the data from the sensing modules may be fused, for example, data synchronization is performed on the point cloud data from the laser radar and its processing result (which may include, for example, the contour feature of the object, the relative position relation between the object and the aircraft, the point cloud data of the contour of the aircraft, etc.) and the data from the inertial navigation system and its processing result (which include, for example, the velocity and acceleration of the aircraft), to acquire the relative velocity between the object and the aircraft. A possible collision time t (second) of each of the one or more objects with the aircraft is calculated according to the relative distance/the relative velocity, wherein the relative distance is determined according to the relative position relation between the object and the aircraft and the contour feature of the aircraft. Therefore, according to the collision time t corresponding to each object, it can be determined whether the corresponding object is secure. In some embodiments, the security collision time T (second) may be preset. When the collision time corresponding to the object t≥2T, it may be determined that the object will not collide (namely, it is determined that the object is secure); when T≤t<2T, it may be determined that the object has a certain collision risk (for example, as described below, it is determined that the object is insecure and the insecurity level is the first level); and when t<T, it may be determined that the object has a higher collision risk (for example, as described below, it is determined that the object is insecure and the insecurity level is the second level).

In some embodiments, in step 120, it may be determined whether the object is secure according to the contour feature of the aircraft and the distance between the object and the aircraft. For example, for an aircraft with a wingspan of 24 m or less, it is determined that the object is secure when the distance between the object and the aircraft is not less than 3 m, otherwise it is determined that the object is insecure; for an aircraft with a wingspan of 24 m to 36 m, it is determined that the object is secure when the distance between the object and the aircraft is not less than 4.5 m, otherwise it is determined that the object is insecure; and for an aircraft with a wingspan of 36 m or more, it is determined that the object is secure when the distance between the object and the aircraft is not less than 7.5 m, otherwise it is determined that the object is insecure.

In response to determining in step 120 that the object is insecure, the collision avoidance measure is implemented in step 130. In some embodiments, the collision avoidance measure may be to give the early-warning signal, for example, the aural signal through the buzzer, or the visual and/or aural signal through the HMI (which may be, for example, the HMI mounted on the towing vehicle or the HMI provided by a handheld electronic device). In some embodiments, the early-warning signal includes the first-level early-warning signal and the second-level early-warning signal. In step 130, in response to determining that the object is insecure and the insecurity level is a first level, the early-warning signal (for example, the early-warning signal indicating that the object is in a warning area) of the first level may be given; and in response to determining that the object is insecure and the insecurity level is the second level, the early-warning signal (for example, the early-warning signal indicating that the object is in a danger area) of the second level may be given. Those skilled in the art should appreciate that in other embodiments, more levels of early-warning signals may be included to respectively perform early-warning of more insecurity levels. In some embodiments, the collision avoidance measure may be to reduce the travel velocity of the aircraft. For example, the travel velocity of the aircraft may be reduced by controlling the braking system of the towing vehicle.

In addition, a screen associated with the aircraft and the object may be displayed in real time on the display screen of the towing vehicle and/or the display screen of the control center for a user (for example, the driver of the towing vehicle and/or crew of the control center, etc.) to view in real time how the surrounding environment is in the travel of the aircraft on the ground. In some embodiments, the screen may include the relative position relation between the aircraft and the object to visually display, to the user, the distance of each object in the surrounding environment of the aircraft to the aircraft, the orientation relative to the aircraft, and the like. It should be understood that the screen may be constructed by the sensing data of the sensing module. In some embodiments, the sensing module includes the laser radar and/or the camera, and the screen may be an image reconstructed based on the point cloud data of the laser radar, an image captured by the camera, a combination of both, or a simple graphical interface on which only information that needs to be displayed is presented.

In other embodiments, the screen may further include other information in order to better provide the service to the user. In one example, the screen may include the category of the object, for example, the screen may, in graphic and/or text manner, indicate that the object is an aircraft, a vehicle, a person, a building, a ground facility, a small-size abnormal thing located on the ground, or the like. In one example, the screen may include the insecurity level of the object. For example, the insecurity level may include the above-described security, insecurity of the first level, insecurity of the second level, and the like, which may be indicated by a graphic, text, and/or a color, and the like. In one example, the screen may include the relative position relation between the towing vehicle and the aircraft. For example, respective positions and attitudes (for example, orientations, etc.) of the towing vehicle and the aircraft may be, in a graphical manner, displayed in the screen to facilitate the driver observing the state of the aircraft when towed. In one example, the screen may include the contour feature of the aircraft and/or the contour feature of the object, for example, the contours of the aircraft and/or the object being, in a graphical manner, presented to facilitate the user visually observing the surrounding environment of the aircraft when traveling on the ground. As described above, the contour feature of the aircraft may be from the point cloud data of the contour of the aircraft that is extracted from the database, and the contour feature of the object may be from the sensing data of the sensing module. In one example, the screen may include the travel feature of the aircraft and/or the travel feature of the object, for example, the velocity(s) of the aircraft and/or the object being marked out in a textual manner, or velocity level(s) of the aircraft and/or the object being displayed in a motional manner (for example, in a velocity of graphic movement, a frequency of flashing, or the like) to facilitate the user visually observing the surrounding environment of the aircraft when travelling on the ground.

In one example, the screen may include the area in which the aircraft travels and the positioning feature of the aircraft within the area, as well as security level(s) of one or more portions of the area. For example, the area in which the aircraft travels, the apron taxiway, the stand taxiway, the runway and the like, which are located around the aircraft may be displayed in a graphical manner, and the position of the aircraft in these areas are displayed. The positioning feature (i.e., position and attitude information) of the towing vehicle can be acquired by the inertial navigation system mounted on the towing vehicle, and the positioning feature of the aircraft can be acquired according to the relative position relation between the towing vehicle and the aircraft, thereby displaying the aircraft in the above area according to the positioning feature of the aircraft. In addition, the security level of each portion of the area may also be displayed. For example, for an area with a fixed obstacle (for example, a maintenance garage, etc.), an apron danger area, a raked zone, and the like, these areas may be highlighted in the screen to alert the user.

A method for ground travel collision avoidance of the aircraft according to one specific embodiment of the present disclosure is described below in conjunction with FIG. 3. In this embodiment, the method for ground travel collision avoidance of the aircraft includes the following steps: (1) environmental perception data acquisition: acquiring laser radar point cloud data, camera video data, and data of the inertial navigation system in real time through the sensing module, such as various sensor devices, mounted on the towing vehicle for the aircraft; (2) perception data preprocessing: performing de-noising, clustering and other processing on the laser radar point cloud data, to obtain information (such as the relative position relation with the towing vehicle) of the object (also called as “the target object”) in the surrounding environment, and performing protocol analysis on the data of the inertial navigation system to obtain the velocity, GPS and other information of the towing vehicle; (3) model automatic identification: performing feature matching on the laser radar data after the preprocessing, automatically identifying the model of the currently towed aircraft, and then acquiring contour feature data of the model through the database; (4) perception data fusion: performing data synchronization on the laser radar point cloud data and the vehicle velocity and GPS information of the inertial navigation system to obtain the relative velocity of the target object with the aircraft; (5) early-warning information decision: calculating the collision time t (second) of each target object with the aircraft through the relative distance/the relative velocity, and when t<a preset security collision time T (second), giving the danger-area early-warning signal; when T≤t<2T, giving the warning-area early-warning signal; and when t≥2T, giving no early-warning signal for the security area; (6) data output: according to the early-warning signal, the HMI performing presentation, and simultaneously, the buzzer performing a sound prompt according to the signal, and uploading the early-warning data to the backend server in real time.

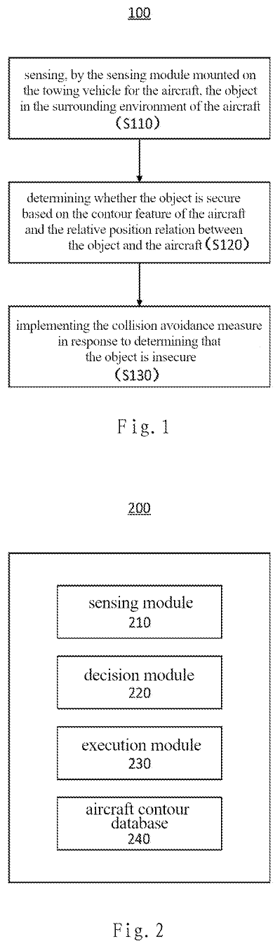

FIG. 2 is an exemplary block diagram of the system 200 for ground travel collision avoidance of the aircraft according to an embodiment of the present disclosure. The system 200 includes the sensing module 210, the decision module 220, the execution module 230, and the aircraft contour database 240. The sensing module 210 is mounted on the towing vehicle for the aircraft, and the decision module 220, the execution module 230, and the aircraft contour database 240 may be on-board modules mounted on the towing vehicle, or remote modules separated from the towing vehicle, for example, modules located on the server. Contour features of various models of aircrafts are stored in the aircraft contour database 240. The contour feature may include point cloud data of the contour of the aircraft and/or dimensions of the contour.

In some embodiments, the sensing module 210 may include the laser radar. The laser radar may be used for sensing the object in the surrounding environment of the aircraft. For example, the object in the surrounding environment of the aircraft may be determined based on three-dimensional point cloud data of the surrounding environment of the aircraft that is sensed by the laser radar. Further, based on the three-dimensional point cloud data of the surrounding environment of the aircraft that is sensed by the laser radar, the contour feature and the travel feature of the object in the environment, and the relative position relation between the object and the aircraft (and/or the towing vehicle) may be determined. The laser radar may further be used for sensing the relative position relation between the aircraft and the towing vehicle. For example, by using point cloud data sensed by the laser radar mounted on the towing vehicle and oriented at least partially toward the aircraft (for example, at least a portion of the aircraft is included within the field angle of view of the laser radar), the relative position relation between the aircraft and the towing vehicle may be determined, or the external feature of the aircraft is sensed, thereby determining the model of the aircraft. In some embodiments, the sensing module 210 may include the inertial navigation system for sensing the travel feature of the towing vehicle, thereby obtaining the travel feature of the aircraft. The travel feature may include, for example, the travel velocity, the travel acceleration, the positioning position, and the like. In some embodiments, the sensing module 210 may include the camera for taking an image of the surrounding environment. Such an image may be presented through the HMI (which may be the HMI located on the towing vehicle or in the control center) to facilitate user's observation of the environment around the aircraft; and may also be used for the sensed external feature of the aircraft, thereby determining the model of the aircraft.

In some embodiments, the decision module 220 determines whether the object is secure based on the contour feature and the travel feature of the aircraft and the relative position relation between the object and the aircraft. The execution module 230 implements the collision avoidance measure in response to the decision module 220 determining that the object is insecure. In some embodiments, the execution module 230 includes the early-warning module, for example, the buzzer and/or the HMI, which gives the early-warning signal in response to the decision module 220 determining that the object is insecure. In some embodiments, the execution module 230 includes the velocity control module, which reduces the travel velocity of the towing vehicle in response to the decision module 220 determining that the object is insecure, thereby reducing the travel velocity of the aircraft. In some embodiments, the decision module 220 determines the model of the aircraft according to the external feature of the aircraft that is sensed by the sensing module or according to manual input, and extracts the contour feature of the aircraft from the aircraft contour database according to the model of the aircraft.

In some embodiments, the system for ground travel collision avoidance of the aircraft may further include the display module. The display module may be provided on the towing vehicle and/or in the control center, and is used for displaying a screen associated with the aircraft and the object. The screen is constructed by the sensing data of the sensing module 210. In some embodiments, the display module may display the relative position relation between the object and the aircraft. In some embodiments, the display module may further display at least one of the following: the category of the object; the insecurity level of the object; the relative position relation between the towing vehicle and the aircraft; the contour feature(s) and/or the travel feature(s) of the aircraft and/or the object; the area in which the aircraft travels, and the positioning feature of the aircraft within the area; or security level(s) of one or more portions of the area.

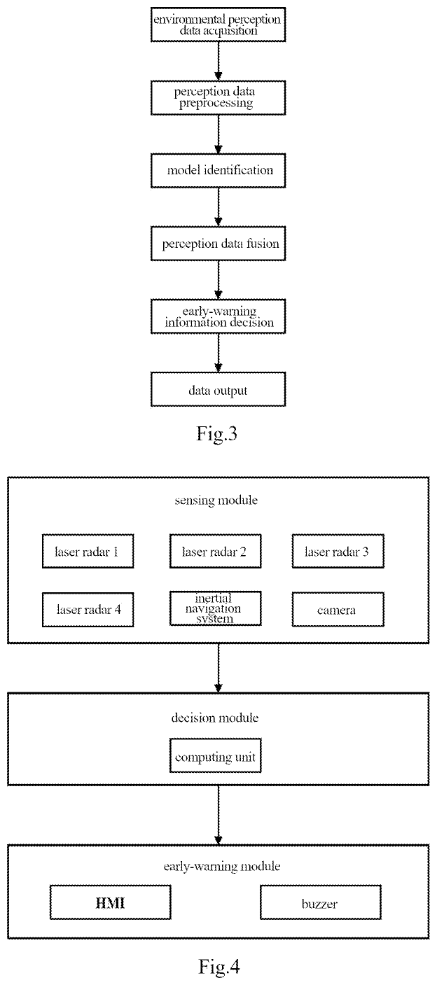

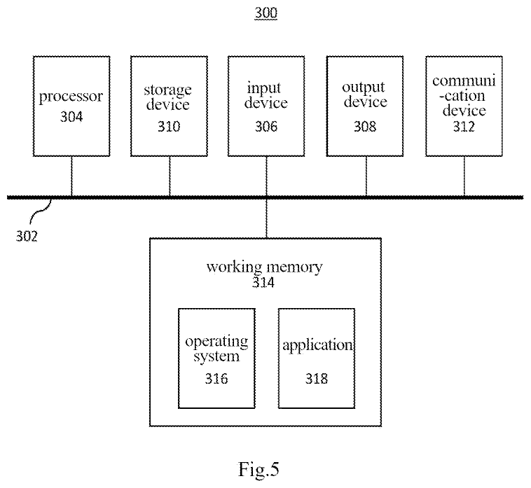

The system for ground travel collision avoidance of the aircraft according to one specific embodiment of the present disclosure is described below in conjunction with FIG. 4. In this embodiment, the system for ground travel collision avoidance of the aircraft includes the sensing module, the decision module, and the early-warning module. The sensing module includes the laser radar, the camera, and the inertial navigation system (called as the inertial navigation system in the figure). In this embodiment, the sensing module includes 4 laser radars, represented as laser radar 1 to laser radar 4 respectively. Each laser radar has a wide field angle of view of horizontal 90° and an effective range of 200 meters, so that a 360° monitoring area can be formed by a combination of the 4 laser radars. Mounting positions of the laser radars on the towing vehicle can be that 2 are mounted in a front of the towing vehicle and 2 are mounted in a rear. Orientations of the 4 laser radars can be that placement with certain deviation angles is formed through test and adjustment, thereby covering a 360° all-round detection area. The laser radar is used for acquiring three-dimensional point cloud data of the surrounding environment, thereby obtaining relative position and velocity information of the target object through data processing. The camera is used for acquiring video data of the surrounding environment. The inertial navigation system is used for acquiring the current velocity, acceleration, and GPS data of the towing vehicle. The decision module includes the computing unit, which is used for performing data fusion on the laser radar point cloud data, the vehicle velocity, the GPS and the like, calculating whether the target object has the possible collision with the aircraft in the aircraft towing process, and giving an early-warning signal. The early-warning module includes the buzzer and the HMI (Human-Machine Interface). The buzzer is used for giving an alarm song according to the early-warning type when receiving the early-warning signal. The HMI is used for presenting, within the monitoring range, the relative position relations of the target object in the surrounding environment to the aircraft as well as the towing vehicle, the atmosphere (for example, a security area, a warning area, and a danger area) of the position area, and the category of the target object (for example, an aircraft, a vehicle, a pedestrian, and the like).

The present disclosure further provides a device for ground travel collision avoidance of the aircraft. The device for ground travel collision avoidance of the aircraft includes one or more processors and one or more memories. The one or more processors are configured to perform the method described above according to the embodiments of the present disclosure. The memory is configured to store data, a program, and the like required by the processor. The program includes a series of computer-executable instructions required by causing the processor to perform the method described above according to the embodiments of the present disclosure. The data includes the data sensed by the sensing module described above, preprocessed/processed data, an input, output, and intermediate result of individual step in the above process, and the like. The one or more memories may be configured to store one item of the above-described content by using one memory, and may also be configured to jointly store one item of the above-described content by using a plurality of memories, or store more than one item of the above-described content by using one memory.

It should be noted that the one or more memories may all be local memories (for example, memories mounted on the collision avoidance apparatus or the towing vehicle), or may all be cloud memories (for example, memories in a cloud server), or may partially be local memories and partially be cloud memories. Similarly, the one or more processors may all be local processors (for example, processors mounted on the collision avoidance device or towing vehicle), or may all be cloud processors (for example, processors in a cloud server), or may partially be local processors and partially be cloud processors.

FIG. 5 is an exemplary block diagram of a general hardware system 300 applicable to various embodiments of the present disclosure. The hardware system 300, which may be an example of a hardware device applied to various aspects of the present disclosure, will now be described with reference to FIG. 5. The hardware system 300 may be any machine configured to perform processing and/or calculation, which may be, but is not limited to, a workstation, a server, a desktop computer, a laptop computer, a tablet computer, a personal data assistant, a smart phone, a vehicle-mounted computer, or any combination thereof. The decision module 220 in the above system 200 for ground travel collision avoidance of an aircraft according to the embodiments of the present disclosure may be implemented, fully or at least partially, by the hardware system 300 or a similar device or system.

The hardware system 300 may include elements connected with or communicating with a bus 302, possibly via one or more interfaces. For example, the hardware system 300 may include a bus 302, as well as one or more processors 304, one or more input devices 306, and one or more output devices 308. The one or more processors 304 may be any type of processor, which may include, but is not limited to, one or more general-purpose processors and/or one or more special-purpose processors (for example, special processing chips). The input device 306 may be any type of device that can input information to a computing apparatuses, which may include, but is not limited to, a camera, a laser radar sensor, an inertial navigation system, a mouse, a keyboard, a touch screen, a microphone and/or a remote control. The output device 308 may be any type of device that can present information, which may include, but is not limited to, a display, a speaker, a buzzer, a video/audio output terminal, a vibrator and/or a printer.

The hardware system 300 may further include a non-transitory storage device 310 or be connected with a non-transitory storage device 310. The non-transitory storage device 310 may be any storage device that is non-transitory and that can implement data storage, which may include, but is not limited to, a disk drive, an optical storage device, a solid-state memory, a floppy disk, a hard disk, a magnetic tape or any other magnetic medium, an optical disk or any other optical medium, a ROM (Read-Only Memory), a RAM (Random Access Memory), a cache memory, and/or any other memory chip/chipset, and/or any other medium from which a computer can read data, instructions, and/or code. The non-transitory storage device 310 may be detached from the interface. The non-transitory storage device 310 may have data/instructions/code for implementing the above methods, steps, and processes. One or more of the one or more memories described above may be implemented by the non-transitory storage device 310.

The hardware system 300 may further include a communication device 312. The communication device 312 may be any type of device or system capable of communicating with an external device and/or a network, which may include, but is not limited to, a modem, a network card, an infrared communication device, a wireless communication device, and/or a chipset, for example, a Bluetooth device, a 1302.11 device, a WiFi device, a WiMax device, a cellular communication device, and/or a similar device.

The hardware system 300 may also be connected to an external device, for example, a GPS receiver, and sensors for sensing different environment data, for example, an acceleration sensor, a wheel velocity sensor, a gyroscope, and so on. In this way, the hardware system 300 may receive, for example, position data and sensor data that indicate travel conditions of a vehicle. When the hardware system 300 is used as a vehicle-mounted device, it may further be connected to another facility (for example, an engine system, wiper, anti-lock braking system, etc.) of a vehicle to control the operation and manipulation of the vehicle.

In addition, the non-transitory storage device 310 may have map information and a software element so that the processor 304 may perform route guidance processing. In addition, the output device 308 may include a display for displaying a map, a position marker of the vehicle, and an image indicating the travel conditions of the vehicle. The output device 308 may further include a speaker or have an interface with headphones for audio guidance.

The bus 302 may include, but is not limited to, an industry standard architecture (ISA) bus, a micro channel architecture (MCA) bus, an enhanced ISA (EISA) bus, a video electronics standards association (VESA) local bus, and a peripheral component interconnect (PCI) bus. In particular, for the vehicle-mounted device, the bus 302 may further include a controller area network (CAN) bus or another architecture designed for application on the vehicle.

The hardware system 300 may further include a working memory 314, which may be any type of working memory that can store instructions and/or data useful for the operation of the processor 304, and may include, but is not limited to, a random access memory and/or a read-only memory device.

The software element may be located in the working memory 314, and includes, but is not limited to, an operating system 316, one or more applications 318, a driver, and/or other data and code. The instructions for performing the method and steps described above may be included in the one or more applications 318. Executable code or source code for instructions of the software element may be stored in a non-transitory computer-readable storage medium, such as the storage device 310 described above, and may be read into the working memory 314 by compilation and/or installation. The executable code or source code for the instructions of the software element may also be downloaded from a remote location.

It should further be understood that variations may be made according to specific requirements. For example, a specific element may also be implemented by using customized hardware, and/or by using hardware, software, firmware, middleware, microcode, hardware description language, or any combination thereof. In addition, a connection with another computing apparatuses, such as a network input/output device, may be employed. For example, some or all of the method or apparatus according to the embodiments of the present disclosure may be implemented by using programming hardware (for example, a programmable logic circuit including a field programmable gate array (FPGA) and/or a programmable logic array (PLA)) in assembly language or hardware programming language (such as VERILOG, VHDL, C++) according to logic and algorithms of the present disclosure.

It should further be understood that components of the hardware system 300 may be distributed across a network. For example, some processes may be performed using one processor, while other processes may be performed by another processor remote from the processor. Other components of the hardware system 300 may also be similarly distributed. In this way, the hardware system 300 may be interpreted as a distributed computing system that performs processing at a plurality of locations.

The method, the system and the device for ground travel collision avoidance of an aircraft provided in this disclosure can remedy a visual blind area of the driver of the towing vehicle, and when the target object is in the warning or danger area in the aircraft towing process, give the early-warning information in time, to assist the driver of the towing vehicle in improving operation security.

In addition, the embodiments of the present disclosure may further include the following examples:
1. A method for ground travel collision avoidance of an aircraft, including:
   sensing, by a sensing module mounted on a towing vehicle for the aircraft, an object in a surrounding environment of the aircraft;
   determining whether the object is secure based on a contour feature of the aircraft and a relative position relation between the object and the aircraft; and
   implementing a collision avoidance measure in response to determining that the object is insecure.
2. The method according to 1, wherein the sensing module includes a laser radar, and the method includes sensing the object in the surrounding environment of the aircraft based on point cloud data sensed by the laser radar.
3. The method according to 1, wherein the collision avoidance measure includes:
   giving an early-warning signal; and/or
   reducing a travel velocity of the aircraft.
4. The method according to 3, wherein the early-warning signal includes a first-level early-warning signal and a second-level early-warning signal, and the method further includes:
   in response to determining that the object is insecure and an insecurity level is a first level, giving the first-level early-warning signal; and
   in response to determining that the object is insecure and the insecurity level is a second level, giving the second-level early-warning signal.
5. The method according to 1, wherein the contour feature of the aircraft includes: point cloud data of a contour of the aircraft; and/or a dimension of the contour of the aircraft.
6. The method according to 1, further including: extracting the contour feature of the aircraft from a pre-established database according to a model of the aircraft.
7. The method according to 6, wherein
   the model of the aircraft is determined according to an external feature of the aircraft sensed by the sensing module; and/or
   the model of the aircraft is determined according to manual input.
8. The method according to 1, further including:
   determining whether the object is secure based on the contour feature and a travel feature of the aircraft and the relative position relation between the object and the aircraft,
   wherein the travel feature includes the travel velocity and a travel acceleration.
9. The method according to 8, further including: acquiring, by the sensing module, the travel feature of the aircraft.
10. The method according to 1, further including:
   sensing, by the sensing module, a contour feature of the object; and
   determining whether the object is secure based on the contour feature of the aircraft, the relative position relation between the object and the aircraft, and the contour feature of the object.
11. The method according to 1, further including:
   displaying a screen associated with the aircraft and the object on a display screen of the towing vehicle and/or a display screen of a control center.
12. The method according to 11, wherein the screen includes the relative position relation between the object and the aircraft.
13. The method according to 12, wherein the screen further includes at least one of:
   a category of the object;
   an insecurity level of the object;
   a relative position relation between the towing vehicle and the aircraft;
   the contour feature(s) and/or the travel feature(s) of the aircraft and/or the object;
   an area in which the aircraft travels, and a positioning feature of the aircraft within the area; or
   security level(s) of one or more portions of the area.
14. The method according to 11, wherein the screen is constructed by the sensing data of the sensing module, the sensing module including the laser radar and/or a camera.
15. A system for ground travel collision avoidance of an aircraft, including:
   a sensing module mounted on a towing vehicle for the aircraft and configured to sense an object in a surrounding environment of the aircraft;
   a decision module configured to determine whether the object is secure based on a contour feature of the aircraft and a relative position relation between the object and the aircraft; and
   an execution module configured to implement a collision avoidance measure in response to determining that the object is insecure.
16. The system according to 15, wherein the sensing module includes a laser radar, and the decision module is further configured to determine the object in the surrounding environment of the aircraft based on point cloud data sensed by the laser radar.
17. The system according to 15, wherein the execution module includes:
   an early-warning module configured to give an early-warning signal in response to determining that the object is insecure; and/or
   a velocity control module configured to reduce a travel velocity of the towing vehicle in response to determining that the object is insecure, thereby reducing a travel velocity of the aircraft.
18. The system according to 17, wherein the early-warning module includes a buzzer and/or a human-machine interface.
19. The system according to 15, further including: an aircraft contour database in which contour features of various models of aircrafts are stored, wherein the decision module is further configured to extract the contour feature of the aircraft from the aircraft contour database according to a model of the aircraft.
20. The system according to 19, wherein the decision module is further configured to:
   determine the model of the aircraft according to an external feature of the aircraft sensed by the sensing module; and/or
   determine the model of the aircraft according to manual input.
21. The system according to 15, wherein
   the sensing module includes an inertial navigation system configured to acquire a travel feature of the aircraft, the travel feature including the travel velocity and a travel acceleration; and
   the decision module is further configured to: determine whether the object is secure based on the contour feature and the travel feature of the aircraft and the relative position relation between the object and the aircraft.
22. The system according to 15, wherein the decision module is further configured to:
   sense, by the sensing module, a contour feature of the object; and
   determine whether the object is secure based on the contour feature of the aircraft, the relative position relation between the object and the aircraft, and the contour feature of the object.
23. The system according to 15, further including:
   a display module provided on the towing vehicle and/or in a control center and configured to display a screen associated with the aircraft and the object.
24. The system according to 23, wherein the display module is further configured to display the relative position relation between the object and the aircraft.
25. The system according to 24, wherein the display module is further configured to display at least one of:
   a category of the object;
   an insecurity level of the object;
   a relative position relation between the towing vehicle and the aircraft;
   the contour feature(s) and/or the travel feature(s) of the aircraft and/or the object;
   an area in which the aircraft travels, and a positioning feature of the aircraft within the area; or
   security level(s) of one or more portions of the area.
26. The system according to 23, wherein the screen is constructed by the sensing data of the sensing module, the sensing module including the laser radar and/or a camera.
27. A device for ground travel collision avoidance of an aircraft, including:
   one or more processors; and
   one or more memories configured to store a series of computer-executable instructions,
   wherein the series of computer-executable instructions, when executed by the one or more processors, cause the one or more processors to perform the method according to any of 1 to 14.
28. A non-transitory computer-readable storage medium characterized in that the non-transitory computer-readable storage medium has thereon stored a series of computer-executable instructions which, when executed by one or more computing apparatuses, cause the one or more computing apparatuses to perform the method of any of 1 to 14.

Although various aspects of the present disclosure have been described with reference to the accompanying drawings so far, the above-described method, system and device are merely exemplary examples, and the scope of the present disclosure is not limited by these aspects, but is only defined by the following aspects: the attached claims and their equivalents. Various elements may be omitted, or replaced with equivalent elements. In addition, these steps may be performed in a different order from that described in the present disclosure. Furthermore, the various elements may be combined in various ways. It is equally important that with the development of technology, many of the described elements can be replaced by equivalent elements which appear after the present disclosure.

What is claimed is:

1. A method for ground travel collision avoidance of an aircraft, comprising:
sensing, by a sensing module mounted on a towing vehicle for the aircraft, an object in a surrounding environment of the aircraft;
determining whether the object is secure based on a contour feature of the aircraft and a relative position relation between the object and the aircraft; and
implementing a collision avoidance measure in response to determining that the object is insecure.

2. The method according to claim 1, wherein the sensing module comprises a laser radar, and the method comprises sensing the object in the surrounding environment of the aircraft based on point cloud data sensed by the laser radar.

3. The method according to claim 1, wherein the collision avoidance measure comprises:
giving an early-warning signal; and/or
reducing a travel velocity of the aircraft.

4. The method according to claim 3, wherein the early-warning signal comprises a first-level early-warning signal and a second-level early-warning signal, the method further comprising:
in response to determining that the object is insecure and an insecurity level is a first level, giving the first-level early-warning signal; and
in response to determining that the object is insecure and the insecurity level is a second level, giving the second-level early-warning signal.

5. The method according to claim 1, wherein the contour feature of the aircraft comprises:
point cloud data of a contour of the aircraft; and/or
a dimension of the contour of the aircraft.

6. The method according to claim 1, further comprising: extracting the contour feature of the aircraft from a pre-established database according to a model of the aircraft.

7. The method according to claim 6, wherein
the model of the aircraft is determined according to an external feature of the aircraft sensed by the sensing module; and/or
the model of the aircraft is determined according to manual input.

8. The method according to claim 1, further comprising:
determining whether the object is secure based on the contour feature and a travel feature of the aircraft, and the relative position relation between the object and the aircraft,
wherein the travel feature comprises the travel velocity and a travel acceleration.

9. The method according claim 1, further comprising:
sensing, by the sensing module, a contour feature of the object; and
determining whether the object is secure based on the contour feature of the aircraft, the relative position relation between the object and the aircraft, and the contour feature of the object.

10. The method according to claim 1, further comprising:
displaying a screen associated with the aircraft and the object on a display screen of the towing vehicle and/or a display screen of a control center, wherein the screen comprises the relative position relation between the object and the aircraft.

11. The method according to claim 10, wherein the screen further comprises at least one of:
a category of the object;
an insecurity level of the object;
a relative position relation between the towing vehicle and the aircraft;
the contour feature(s) and/or the travel feature(s) of the aircraft and/or the object;
an area in which the aircraft travels, and a positioning feature of the aircraft within the area; or
security level(s) of one or more portions of the area.

12. The method according to claim 10, wherein the screen is constructed by the sensing data of the sensing module, and the sensing module comprises the laser radar and/or a camera.

13. A system for ground travel collision avoidance of an aircraft, comprising:
a sensing module mounted on a towing vehicle for the aircraft and configured to sense an object in a surrounding environment of the aircraft;
a decision module configured to determine whether the object is secure based on a contour feature of the aircraft and a relative position relation between the object and the aircraft; and
an execution module configured to implement a collision avoidance measure in response to determining that the object is insecure,
wherein the sensing module comprises a laser radar, and the decision module is further configured to determine the object in the surrounding environment of the aircraft based on point cloud data sensed by the laser radar.

14. The system according to claim 13, wherein the execution module comprises:
an early-warning module configured to give an early-warning signal in response to determining that the object is insecure; and/or
a velocity control module configured to reduce a travel velocity of the towing vehicle in response to determining that the object is insecure, thereby reducing a travel velocity of the aircraft, wherein the early-warning module comprises a buzzer and/or a human-machine interface.

15. The system according to claim 13, further comprising: an aircraft contour database in which contour features of various models of aircrafts are stored,
wherein the decision module is further configured to:
extract the contour feature of the aircraft from the aircraft contour database according to a model of the aircraft, and
determine the model of the aircraft according to an external feature of the aircraft sensed by the sensing module; and/or
determine the model of the aircraft according to manual input.
